(19) United States
(12) Patent Application Publication
(10) Pub. No.: US 2024/0419589 A1
(43) Pub. Date: Dec. 19, 2024

(54) PREFETCHING RELATED APPLICATION FILES IN AN INFORMATION HANDLING SYSTEM

(71) Applicant: Dell Products L.P., Round Rock, TX (US)

(72) Inventors: Young Hwan Jang, Gwangju (KR); Chai Im Teoh, Singapore (SG); Hwai Bing Jonathan Yap, Singapore (SG)

(73) Assignee: Dell Products L.P., Round Rock, TX (US)

(21) Appl. No.: 18/336,309

(22) Filed: Jun. 16, 2023

(51) Int. Cl. G06F 12/06; G06F 8/61

(52) U.S. Cl. CPC G06F 12/0646; G06F 8/61; G06F 2212/251

(57) ABSTRACT

Aspects of this disclosure implement a method of assigning an identification number to a plurality of files associated with an application and storing the plurality of files in a non-volatile memory such that the plurality of files are stored in contiguous physical memory locations based on the identification number. The storing of the plurality of files in contiguous physical memory locations based on the identification number makes it easier for the non-volatile memory to cache at least one other file of the plurality of files upon a first read of a first file of the plurality of files. Other aspects are also disclosed.

### FIELD OF THE DISCLOSURE

The instant disclosure relates to information handling systems. More specifically, portions of this disclosure relate to assigning an identification number to a plurality of files associated with an application for efficient caching during execution of the application.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

An information handling system may efficiently prefetch a plurality of files associated with an application based on an identification number assigned to the plurality of files based on their association with the application. This method increases performance and speed compared to performing random read operations while executing an application.

Aspects of the disclosure implement a method of assigning an identification number to a plurality of files associated with an application and storing the plurality of files in a non-volatile memory such that the plurality of files are stored in contiguous physical memory locations based on the identification number. The storing of the plurality of files in contiguous physical memory locations based on the identification number makes it easier for the non-volatile memory to cache or “prefetch” at least one other file of the plurality of files upon a first read of a first file of the plurality of files.

In some embodiments, the prefetching techniques described herein may reduce the negative effect of performance loss when storing data in multi-level cells (MLCs) in a solid state drive. However, shortcomings mentioned here are only representative and are included to highlight problems that the inventors have identified with respect to existing information handling systems and sought to improve upon. Aspects of the information handling systems described below may address some or all of the shortcomings as well as others known in the art. Aspects of the improved information handling systems described below may present other benefits than, and be used in other applications than, those described above.

According to one embodiment, a method may comprise: assigning, by the information handling system, an identification number to a plurality of files associated with an application; and storing, by the information handing system, the plurality of files in a non-volatile memory such that the plurality of files are stored in contiguous physical memory locations based on the identification number.

According to some embodiments of the disclosure, the assignation of identification number is performed during installation of the application, and the method further comprises assigning the identification number to a second plurality of files associated with the application during an update of the application.

The method may further comprise retrieving a first file of the plurality of files from the non-volatile memory; and based on retrieving the first file, caching at least one other file of the plurality of files.

According to some embodiments of the disclosure, storing the plurality of files in contiguous memory locations is performed regardless of logical addresses corresponding to the plurality of files not being contiguous memory locations.

The method of claim 1, wherein storing the plurality of files in the non-volatile memory comprises storing the plurality of files in consecutive physical NAND pages of the non-volatile memory.

The method of claim 1, wherein the application comprises a gaming application and the plurality of files comprise texture files. Further, according to some embodiments, the plurality of files comprise texture files corresponding a first portion (e.g., first level, first scene) of the gaming application and the identification number identifies the texture files corresponding to the first portion, the method further comprising: assigning, by the information handling system, a second identification number to a second plurality of files corresponding to a second portion of the gaming application; storing, by the information handling system, the second plurality of files in the non-volatile memory such that the second plurality of files are stored in contiguous physical memory locations based on the second identification number; retrieving a second file of the second plurality of files from the non-volatile memory; and based on retrieving the second file, caching at least one other second file of the second plurality of files.

The method may further comprise receiving, by the information handling system, an indication of a current state of the gaming application; determining, by the information handling system, whether the identification number corresponds to the current state of the gaming application; and caching, by the information handling system, at least one other file of the plurality of files assigned the identification number based on determining the identification number corresponds to the current state of the gaming application according to certain embodiments of the disclosure. The method may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, audio controller, or similar electronic computing device that manipulates and transforms data represented as physical (electronic) quantities within the computer system's registers and memories into other data similarly represented as physical quantities within the computer system's registers, memories, or other such information storage, transmission, or display devices.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating two applications of an information handling system and the plurality of files associated with each application, respectively, stored consecutively in a non-volatile memory according to certain embodiments of the disclosure.

FIG. 2 is a block diagram illustrating the caching of at least one file of a plurality of files after a first read of a file of the same identification number according to certain embodiments of the disclosure.

FIG. 3 is flowchart diagram illustrating a method of assigning an identification number to a plurality of files and storing the plurality of files in contiguous physical memory locations based on the identification number according to some embodiments of the disclosure.

FIG. 4 is a flowchart diagram illustrating the assignation of an identification number to a plurality of files associated with an application during an installation or update according to certain embodiments of the disclosure.

FIG. 5 is a flowchart diagram illustrating the caching of at least one file of a plurality of files after a first read of a file of the same identification number according to certain embodiments of the disclosure.

FIG. 6 is a flowchart diagram illustrating the caching of at least one file of a plurality of files assigned an identification number based on determining the identification number corresponds to a current state of an application according to some embodiments of the disclosure.

FIG. 7 is a schematic block diagram of an example information handling system according to some embodiments of the disclosure.

### DETAILED DESCRIPTION

Aspects of the disclosure include apparatuses, configurations, and/or methods for improving read performance for execution of an application. In one embodiment of the disclosure, a plurality of files associated with an application are assigned an identification number and stored in contiguous physical memory locations in a non-volatile memory based on the identification number.

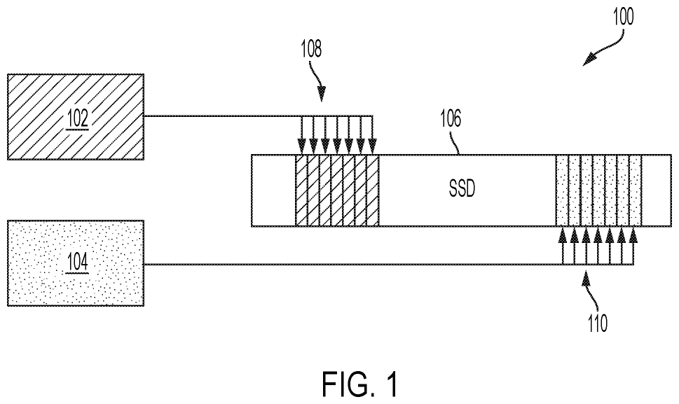

FIG. 1 illustrates two applications of an information handling system and the plurality of files associated with each application, respectively, stored consecutively in a non-volatile memory according to certain embodiments of the disclosure. Block diagram 100 depicts applications 102, 104 utilizing a non-volatile memory 106, such as an SSD. Applications 102, 104 may be, for example, gaming applications, or any application executable on the information handling system. Each application 102, 104 stores a plurality of files 108, 110 on the non-volatile memory 106 associated with each respective application 102, 104. The plurality of files 108, 110 may be texture files according to certain embodiments of the disclosure. The plurality of files 108, 110 are stored in the non-volatile memory 106 based, at least in part, on an identification number assigned by the information handling system. The plurality of files 108, 110 may be stored in contiguous memory locations regardless of logical addresses corresponding to the plurality of files not being contiguous memory locations. For example, the plurality of files 108, 110 may be stored in consecutive physical NAND pages of the non-volatile memory 106. The identification number may be assigned based, at least in part, on the plurality of files' 108, 110 association with an application 102, 104 of the information handling system. The assignation of the identification number is performed during the installation of an application 102, 104 and/or during any sequential update of the application. For example, the method may further comprise assigning the identification number to a second plurality of files associated with the application during an update of the application.

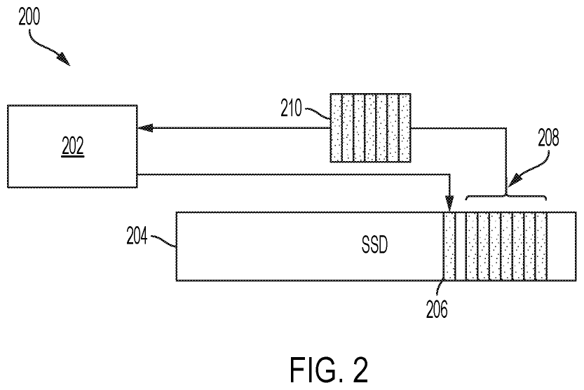

FIG. 2 illustrates the caching of at least one file of a plurality of files after a first read of a file of the same identification number according to certain embodiments of the disclosure. Block diagram 200 depicts an application 202 retrieving a first file 206 of the plurality of files 208 from the non-volatile memory 204 and, based on retrieving the first file 206, caching at least one other file of the plurality of files 208. In some embodiments, at any first read of a file 206 assigned with an identification number, the non-volatile memory 204 target prefetches the remainder of the plurality of files 208 with the same identification number into a read cache 210 before host commands are issued to the non-volatile memory 204. The subsequent read commands may be served from the read cache 204 (e.g., SLC) rather than slower media, such as TLC/QLC. In some embodiments, the plurality of files 208 may be stored sequentially with the first file 206 and stored with a similar identifier, such as a stream identifier. The stream identifier may be communicated to the non-volatile memory 204 using a stream directive or other directive that allows the passing of metadata between hosts and controllers. In some embodiments, the metadata may be communicated using the NVMe stream directive defined in the NVM Express Base Specification Revision 1.3d dated Mar. 20, 2019, which is hereby incorporated by reference herein. The storing of block 304 in contiguous physical memory locations may thus be accomplished, in some embodiments, by assigning a stream ID in block 302 to files related to an application, textures related to a gaming application, textures related to a particular level or segment of a gaming application, and signaling the stream ID to the non-volatile memory through a stream directive.

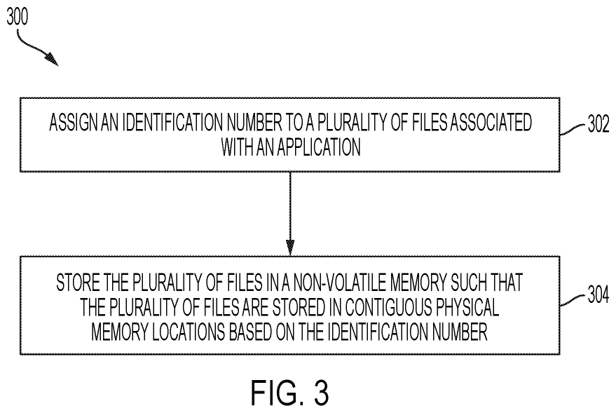

Referring to FIG. 3, method 300 illustrates assigning an identification number to a plurality of files at block 302 and storing the plurality of files in a non-volatile memory such that the plurality of files are stored in contiguous physical memory locations based on the identification number at block 304. According to some embodiments of the disclosure, the plurality of files may comprise texture files corresponding a first portion of a gaming application, such as a first level or first scene. The identification number may identify the texture files corresponding to the first portion, wherein the method may further comprise assigning a second identification number to a second plurality of files corresponding to a second portion of the gaming application. The second plurality of files may be stored in the non-volatile memory in contiguous physical memory locations based on the second identification number. The method may further comprise retrieving a second file of the second plurality of files from the non-volatile memory, and based on retrieving the second file, caching at least one other second file of the second plurality of files.

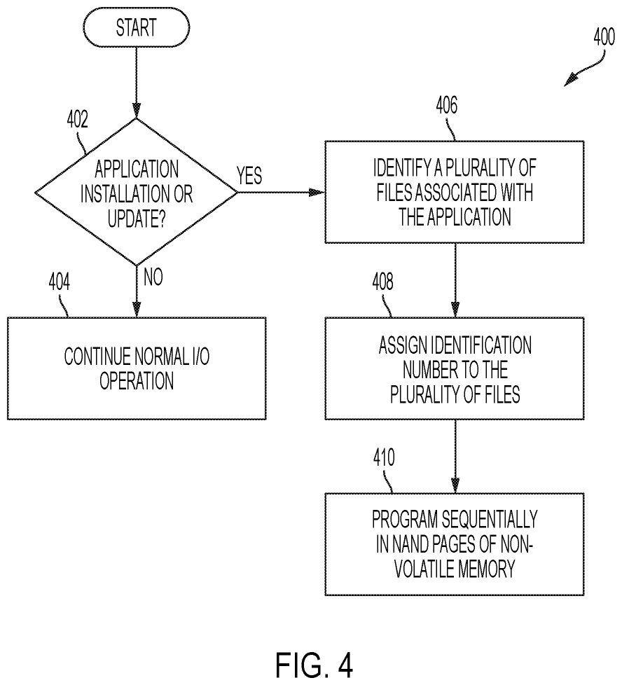

FIG. 4 illustrates the assignation of an identification number to a plurality of files associated with an application during an installation or update according to certain embodiments of the disclosure. Method 400 depicts the information handling system determining whether an application is being installed or updated at block 402. If there is not an installation or update occurring, the information handling system proceeds with normal I/O operations at block 404. However, if the application is being installed/updated, the information handling system identifies a plurality of files associated with the application at block 406. The information handling system may assign the identified plurality of files with an identification number correlating to the application at block 408. The information handling system may then program the plurality of files sequentially into NAND pages of a non-volatile memory of the information handling system at block 410.

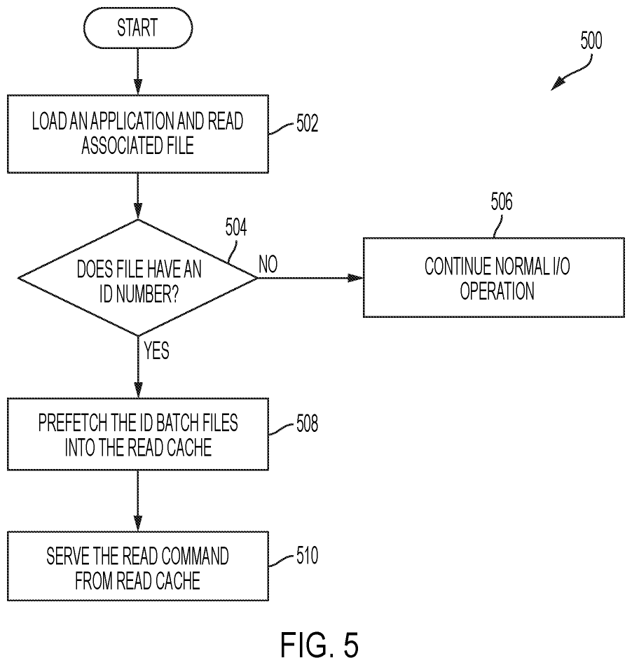

FIG. 5 illustrates the caching of at least one file of a plurality of files after a first read of a file of the same identification number according to certain embodiments of the disclosure. Method 500 depicts an information handling system loading an application and reading an associated file at block 502. If the file does not have an assigned identification number at block 504, the information handling system proceeds with normal I/O operations at block 506. If the file does have an assigned identification number, the non-volatile memory may prefetch a batch of files with the same identification number into the read cache at block 508 before host commands are issued to the non-volatile memory. The firmware may then serve the future read commands from the read cache at block 510 which improves user experience and the performance of the non-volatile memory by reducing the random read operations.

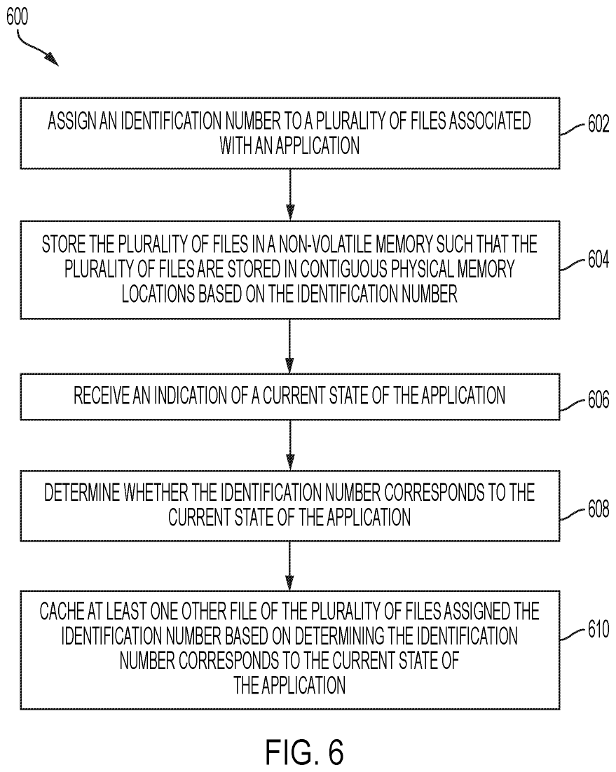

FIG. 6 illustrates the caching of at least one file of a plurality of files assigned an identification number based on determining the identification number corresponds to a current state of an application. Referring to FIG. 6, method 600, similar to method 300 of FIG. 3, assigns an identification number to a plurality of files associated with an application at block 602 and proceeds to block 604 to store the plurality of files in a non-volatile memory such that the plurality of files are stored in contiguous physical memory locations based on the assigned identification number. The information handling system may then receive an indication of a current state of the application at block 606. The information handling system determines whether the identification number corresponds to the current state of the application at block 608 and, if so, proceeds to block 610 to cache at least one other file of the plurality of files assigned the identification number based, at least in part, on determining the identification number corresponds to the current state of the application.

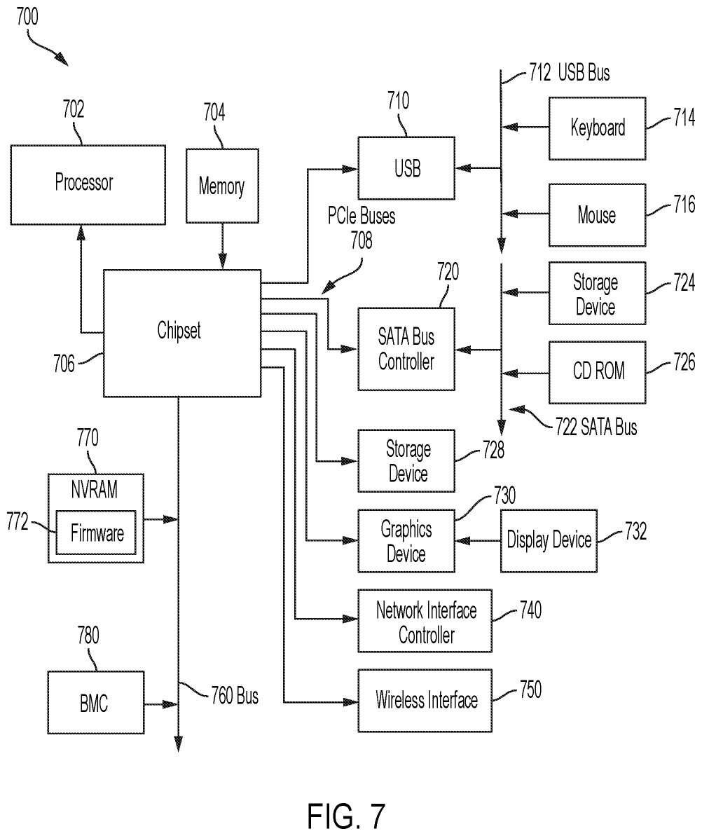

The storing of related application files using an identifier to improve read access times for the application files may improve the responsiveness of an information handling system and thus improve a user experience interacting with the information handling system. For example, with a gaming application the long delays encountered when loading a gaming application and/or when changing worlds and/or advancing levels may be reduced. An example information handling system that may embody one or more aspects of this disclosure is shown in FIG. 7.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components. One example configuration of an information handling system is described with reference to FIG. 7.

FIG. 7 illustrates an example information handling system 700. Information handling system 700 may include a processor 702 (e.g., a central processing unit (CPU)), a memory (e.g., a dynamic random-access memory (DRAM)) 704, and a chipset 706. In some embodiments, one or more of the processor 702, the memory 704, and the chipset 706 may be included on a motherboard (also referred to as a mainboard), which is a printed circuit board (PCB) with embedded conductors organized as transmission lines between the processor 702, the memory 704, the chipset 706, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 702, the memory 704, the chipset 706, and/or other components may be organized as a System on Chip (SoC).

The processor 702 may execute program code by accessing instructions loaded into memory 704 from a storage device, executing the instructions to operate on data also loaded into memory 704 from a storage device, and generate output data that is stored back into memory 704 or sent to another component. The processor 702 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 702 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 706 may facilitate the transfer of data between the processor 702, the memory 704, and other components. In some embodiments, chipset 706 may include two or more integrated circuits (ICs), such as a northbridge controller coupled to the processor 702, the memory 704, and a southbridge controller, with the southbridge controller coupled to the other components such as USB 710, SATA 720, and PCIe buses 708. The chipset 706 may couple to other components through one or more PCIe buses 708.

Some components may be coupled to one bus line of the PCIe buses 708, whereas some components may be coupled to more than one bus line of the PCIe buses 708. One example component is a universal serial bus (USB) controller 710, which interfaces the chipset 706 to a USB bus 712. A USB bus 712 may couple input/output components such as a keyboard 714 and a mouse 716, but also other components such as USB flash drives, or another information handling system. Another example component is a SATA bus controller 720, which couples the chipset 706 to a SATA bus 722. The SATA bus 722 may facilitate efficient transfer of data between the chipset 706 and components coupled to the chipset 706 and a storage device 724 (e.g., a hard disk drive (HDD) or solid-state disk drive (SDD)) and/or a compact disc read-only memory (CD-ROM) 726. The PCIe bus 708 may also couple the chipset 706 directly to a storage device 728 (e.g., a solid-state disk drive (SDD)). A further example of an example component is a graphics device 730 (e.g., a graphics processing unit (GPU)) for generating output to a display device 732, a network interface controller (NIC) 740, and/or a wireless interface 750 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

The chipset 706 may also be coupled to a serial peripheral interface (SPI) and/or Inter-Integrated Circuit (I2C) bus 760, which couples the chipset 706 to system management components. For example, a non-volatile random-access memory (NVRAM) 770 for storing firmware 772 may be coupled to the bus 760. As another example, a controller, such as a baseboard management controller (BMC) 780, may be coupled to the chipset 706 through the bus 760. BMC 780 may be referred to as a service processor or embedded controller (EC). Capabilities and functions provided by BMC 780 may vary considerably based on the type of information handling system. For example, the term baseboard management system may be used to describe an embedded processor included at a server, while an embedded controller may be found in a consumer-level device. As disclosed herein, BMC 780 represents a processing device different from processor 702, which provides various management functions for information handling system 700. For example, an embedded controller may be responsible for power management, cooling management, and the like. An embedded controller included at a data storage system may be referred to as a storage enclosure processor or a chassis processor.

System 700 may include additional processors that are configured to provide localized or specific control functions, such as a battery management controller. Bus 760 can include one or more busses, including a Serial Peripheral Interface (SPI) bus, an Inter-Integrated Circuit (I2C) bus, a system management bus (SMBUS), a power management bus (PMBUS), or the like. BMC 780 may be configured to provide out-of-band access to devices at information handling system 700. Out-of-band access in the context of the bus 760 may refer to operations performed prior to execution of firmware 772 by processor 702 to initialize operation of system 700.

Firmware 772 may include instructions executable by processor 102 to initialize and test the hardware components of system 700. For example, the instructions may cause the processor 702 to execute a power-on self-test (POST). The instructions may further cause the processor 702 to load a boot loader or an operating system (OS) from a mass storage device. Firmware 772 additionally may provide an abstraction layer for the hardware, such as a consistent way for application programs and operating systems to interact with the keyboard, display, and other input/output devices. When power is first applied to information handling system 700, the system may begin a sequence of initialization procedures, such as a boot procedure or a secure boot procedure. During the initialization sequence, also referred to as a boot sequence, components of system 700 may be configured and enabled for operation and device drivers may be installed. Device drivers may provide an interface through which other components of the system 700 can communicate with a corresponding device. The firmware 772 may include a basic input-output system (BIOS) and/or include a unified extensible firmware interface (UEFI). Firmware 772 may also include one or more firmware modules of the information handling system. Additionally, configuration settings for the firmware 772 and firmware of the information handling system 700 may be stored in the NVRAM 770. NVRAM 770 may, for example, be a non-volatile firmware memory of the information handling system 700 and may store a firmware memory map namespace 700 of the information handling system. NVRAM 770 may further store one or more container-specific firmware memory map namespaces for one or more containers concurrently executed by the information handling system.

Information handling system 700 may include additional components and additional busses, not shown for clarity. For example, system 700 may include multiple processor cores (either within processor 702 or separately coupled to the chipset 706 or through the PCIe buses 708), audio devices (such as may be coupled to the chipset 706 through one of the PCIe busses 708), or the like. While a particular arrangement of bus technologies and interconnections is illustrated for the purpose of example, one of skill will appreciate that the techniques disclosed herein are applicable to other system architectures. System 700 may include multiple processors and/or redundant bus controllers. In some embodiments, one or more components may be integrated together in an integrated circuit (IC), which is circuitry built on a common substrate. For example, portions of chipset 706 can be integrated within processor 702. Additional components of information handling system 700 may include one or more storage devices that may store machine-executable code, one or more communications ports for communicating with external devices, and various input and output (I/O) devices, such as a keyboard, a mouse, and a video display.

In some embodiments, processor 702 may include multiple processors, such as multiple processing cores for parallel processing by the information handling system 700. For example, the information handling system 700 may include a server comprising multiple processors for parallel processing. In some embodiments, the information handling system 700 may support virtual machine (VM) operation, with multiple virtualized instances of one or more operating systems executed in parallel by the information handling system 700. For example, resources, such as processors or processing cores of the information handling system may be assigned to multiple containerized instances of one or more operating systems of the information handling system 700 executed in parallel. A container may, for example, be a virtual machine executed by the information handling system 700 for execution of an instance of an operating system by the information handling system 700. Thus, for example, multiple users may remotely connect to the information handling system 700, such as in a cloud computing configuration, to utilize resources of the information handling system 700, such as memory, processors, and other hardware, firmware, and software capabilities of the information handling system 700. Parallel execution of multiple containers by the information handling system 700 may allow the information handling system 700 to execute tasks for multiple users in parallel secure virtual environments.

The schematic flow chart diagrams of FIGS. 3, 4, 5, and 6 are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Certain elements of embodiments described in this specification have been labeled as modules. A module may include a component of that information handling system suitably programmed to operate according to executable instructions. For example, a module may be implemented as a hardware circuit comprising custom VLSI circuits or gate arrays, semiconductor chips comprising logic circuitry, transistors, or other discrete components. A module may also be implemented in programmable hardware devices such as field programmable gate arrays, programmable array logic, programmable logic devices, a controller, or the like.

Modules may also include software-defined units or instructions that, when executed by a component of an information handling system, retrieve and transform data stored on a data storage device from a first state to a second state. An identified module of executable code may, for example, comprise one or more physical blocks of computer instructions which may be organized as an object, procedure, or function. The executables of an identified module need not be physically located together, but may comprise disparate instructions stored in different locations which, when joined logically together, comprise the module, and when executed by the processor, achieve the stated data transformation.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

The operations described above as performed by a controller may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuitry may be configured as a general purpose processor capable of executing instructions contained in software and/or firmware.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Further, a device or system that is configured in a certain way is configured in at least that way, but it can also be configured in other ways than those specifically described. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
assigning, by an information handling system, an identification number to a plurality of files associated with an application; and
storing, by the information handling system, the plurality of files in a non-volatile memory such that the plurality of files are stored in contiguous physical memory locations based on the identification number.

2. The method of claim 1, wherein assigning the identification number is performed during installation of the application, and the method further comprises assigning the identification number to a second plurality of files associated with the application during an update of the application.

3. The method of claim 1, further comprising:
retrieving a first file of the plurality of files from the non-volatile memory; and
based on retrieving the first file, caching at least one other file of the plurality of files.

4. The method of claim 1, wherein storing the plurality of files in contiguous memory locations is performed regardless of logical addresses corresponding to the plurality of files not being contiguous memory locations.

5. The method of claim 1, wherein storing the plurality of files in the non-volatile memory comprises storing the plurality of files in consecutive physical NAND pages of the non-volatile memory.

6. The method of claim 1, wherein the application comprises a gaming application and the plurality of files comprise texture files.

7. The method of claim 6, wherein the plurality of files comprise texture files corresponding a first portion of the gaming application and the identification number identifies the texture files corresponding to the first portion, the method further comprising:
assigning, by the information handling system, a second identification number to a second plurality of files corresponding to a second portion of the gaming application;
storing, by the information handling system, the second plurality of files in the non-volatile memory such that the second plurality of files are stored in contiguous physical memory locations based on the second identification number;
retrieving a second file of the second plurality of files from the non-volatile memory; and
based on retrieving the second file, caching at least one other second file of the second plurality of files.

8. The method of claim 6, further comprising:
receiving, by the information handling system, an indication of a current state of the gaming application;
determining, by the information handling system, whether the identification number corresponds to the current state of the gaming application; and
caching, by the information handling system, at least one other file of the plurality of files assigned the identification number based on determining the identification number corresponds to the current state of the gaming application.

9. An information handling system, comprising:
a memory;
a processor coupled to the memory, wherein the processor is configured to perform steps comprising:
assigning an identification number to a plurality of files associated with an application; and
storing the plurality of files in a non-volatile memory such that the plurality of files are stored in contiguous physical memory locations based on the identification number.

10. The information handling system of claim 9, wherein assigning the identification number is performed during installation of the application, wherein the processor is further configured to perform steps comprising assigning the identification number to a second plurality of files associated with the application during an update of the application.

11. The information handling system of claim 9, wherein the processor is further configured to perform steps comprising:
retrieving a first file of the plurality of files from the non-volatile memory; and
based on retrieving the first file, caching at least one other file of the plurality of files.

12. The information handling system of claim 9, wherein storing the plurality of files in contiguous memory locations is performed regardless of logical addresses corresponding to the plurality of files not being contiguous memory locations.

13. The information handling system of claim 9, wherein the plurality of files comprise texture files corresponding a first portion of a gaming application and the identification number identifies the texture files corresponding to the first portion, wherein the processor is further configured to perform steps comprising:
assigning a second identification number to a second plurality of files corresponding to a second portion of the gaming application;
storing the second plurality of files in the non-volatile memory such that the second plurality of files are stored in contiguous physical memory locations based on the second identification number;
retrieving a second file of the second plurality of files from the non-volatile memory; and
based on retrieving the second file, caching at least one other second file of the second plurality of files.

14. The information handling system of claim 9, wherein the processor is further configured to perform steps comprising:
receiving an indication of a current state of the application;
determining whether the identification number corresponds to the current state of the application; and
caching at least one other file of the plurality of files assigned the identification number based on determining the identification number corresponds to the current state of the application.

15. A computer program product, comprising:
a non-transitory computer readable medium, wherein the non-transitory computer readable medium comprises instructions that when executed by a processor of an information handling system to perform steps comprising:
assigning an identification number to a plurality of files associated with an application; and
storing the plurality of files in a non-volatile memory such that the plurality of files are stored in contiguous physical memory locations based on the identification number.

16. The computer program product of claim 15, wherein assigning the identification number is performed during installation of the application, wherein the non-transitory computer readable medium further includes instructions to cause a processor to perform steps comprising assigning the identification number to a second plurality of files associated with the application during an update of the application.

17. The computer program product of claim 15, wherein the non-transitory computer readable medium further includes instructions to cause a processor to perform steps comprising:
retrieving a first file of the plurality of files from the non-volatile memory; and
based on retrieving the first file, caching at least one other file of the plurality of files.

18. The computer program product of claim 15, wherein storing the plurality of files in contiguous memory locations is performed regardless of logical addresses corresponding to the plurality of files not being contiguous memory locations.

19. The computer program product of claim 15, wherein the plurality of files comprise texture files corresponding a first portion of a gaming application and the identification number identifies the texture files corresponding to the first portion, wherein the non-transitory computer readable medium further includes instructions to cause a processor to perform steps comprising
assigning a second identification number to a second plurality of files corresponding to a second portion of the gaming application;
storing the second plurality of files in the non-volatile memory such that the second plurality of files are stored in contiguous physical memory locations based on the second identification number;
retrieving a second file of the second plurality of files from the non-volatile memory; and
based on retrieving the second file, caching at least one other second file of the second plurality of files.

20. The computer program product of claim 15, wherein the non-transitory computer readable medium further includes instructions to cause a processor to perform steps comprising:
receiving, by the information handling system, an indication of a current state of a gaming application;
determining, by the information handling system, whether the identification number corresponds to the current state of the gaming application; and
caching, by the information handling system, at least one other file of the plurality of files assigned the identification number based on determining the identification number corresponds to the current state of the gaming application.
